(19) United States
(12) Patent Application Publication
(10) Pub. No.: US 2010/0178229 A1
(43) Pub. Date: Jul. 15, 2010

(54) ELEMENTAL SOLVENTS

(75) Inventors: Martin John Earle, Belfast (GB); Eva Boros, Belfast (GB); Kenneth Richard Seddon, Belfast (GB); Manuela A. Gilea, Belfast (GB); Joseph S. Vyle, Belfast (GB)

Correspondence Address: CARSTENS & CAHOON, LLP, P O BOX 802334, DALLAS, TX, 75380, US

(73) Assignee: THE QUEEN'S UNI.IONIC LIQUID LAB. RESEARCH CENTRE, Belfast (GB)

(21) Appl. No.: 12/063,762

(22) PCT Filed: Aug. 21, 2006
(86) PCT No.: PCT/GB06/03113

§ 371 Date: Apr. 1, 2008

(30) Foreign Application Priority Data
Aug. 19, 2005 (GB) 0517080.8

(51) Int. Cl. B08B 3/04; C01B 17/02; C01B 25/02; C01B 19/02

(52) U.S. Cl. 423/322; 252/364; 423/567.1; 423/510

(57) ABSTRACT

Use of ionic liquids as solvents for elements such as phosphorus, selenium, tellurium and sulphur, and compounds thereof.

The present invention relates to the use of ionic liquids as solvents for elements such as phosphorus, selenium, tellurium and sulphur, and compounds thereof.

Sulphur is considered a highly important raw material in the chemical industry, and sulphur-containing compounds are essential for all life. Accordingly, its chemistry is of great significance, but has been limited due to a lack of suitable solvents, which provide both good solubility and are environmentally safe to work with.

The best known solvent is carbon disulfide (CS₂) (solubility of sulphur: 0.34 g g⁻¹ at 17° C.). However, carbon disulfide is not a universally suitable solvent due to its disadvantageous and harmful physical properties, which include high toxicity, volatility, flammability, and low boiling point.

Also known for dissolving sulphur is sulphur monochloride (Cl₂S₂). However, like carbon disulfide, this solvent is difficult to work with due to its toxicity, low vapour pressure and sensitivity to moisture (reacts violently with water to form hydrogen chloride, sulphur dioxide and hydrogen sulfide).

Accordingly there is a need to develop solvents which would make the study of sulphur (as well as phosphorus, selenium and tellurium) chemistry easier and safer, and enable industrial scale processes which are more environmentally friendly.

Ionic liquids are a novel class of solvents which have been developed over the last few years.

The term “ionic liquid” as used herein refers to a liquid that is capable of being produced by melting a solid, and when so produced, consists solely of ions. Ionic liquids may be derived from organic salts.

An ionic liquid may be formed from a homogeneous substance comprising one species of cation and one species of anion, or can be composed of more than one species of cation and/or anion. Thus, an ionic liquid may be composed of more than one species of cation and one species of anion. An ionic liquid may further be composed of one species of cation, and one or more species of anion. Thus the mixed salts of the invention can comprise mixed salts containing anions and cations.

In summary, the term “ionic liquid” as used herein may refer to a homogeneous composition consisting of a single salt (one cationic species and one anionic species) or it may refer to a heterogeneous composition containing more than one species of cation and/or more than one species of anion.

The main advantages of ionic liquids compared to molecular solvents are their non-volatility, low toxicity, low flammability, applicability at wide temperature ranges (200-250° C.) and the possibility of recycling, which properties make them environmentally friendly. Such solvents are of course greatly desired for industrial processes. In addition, because of their ionic structure, they often change the reactivity of common reagents or the regio- or stereoselectivity of the reactions resulting in faster reactions and higher yields.

The great variety of possible cations and anions make their physical properties, like viscosity, density, water-solubility etc. “tuneable” for almost all reactions.

The inventors of the present invention have developed a range of ionic liquids which can be used as solvents for elements selected from phosphorus, selenium, tellurium and/or sulphur, thereby avoiding the need to use highly toxic and environmentally unfriendly hitherto known solvents.

The present invention describes the use of specifically developed ionic liquids as solvents for phosphorus, selenium, tellurium and sulphur, preferably sulphur and selenium and most preferably sulphur. By utilising ionic liquids as solvents, it is possible to undertake chemical reactions as well as purification and recrystallisation of elemental phosphorus, selenium, tellurium and sulphur, preferably sulphur.

The term “elemental” means that the element is not combined in a molecule containing any other element. Thus, in the case of sulphur, the sulphur may be in the S₈ elemental form, i.e. in the form of octomeric molecular S₈.

Further, use of the ionic liquids avoids the need for dangerous toxic solvents like carbon disulfide and sulphur monochloride.

According to one aspect of the present invention, there is provided use of an ionic liquid as a solvent for phosphorus, selenium, tellurium and/or sulphur, the ionic liquid being composed of at least one species of cation, and at least one species of soft anion. Preferably, the ionic liquid is used as a sulphur or selenium solvent, most preferably as a sulphur solvent.

The principle of hard and soft ions is well-known in chemistry (See Advanced Organic Chemistry, March J; and d-Block Chemistry, Winter M. J). Soft ions are those of low electronegativity, and high polarizability. In contrast, hard ions have high electronegativity, and low polarizability, for example, [SO₃OR]⁻.

Although not bound by any theory, the inventors of the present invention believe that the elements S, Se, Te, P, As, Sg and ions Br⁻, I⁻ and (Cl⁻—not as much) increase solubility when present in the anion, compared with F>O>N, i.e. F has the greatest solubility reducing effect.

Preferably, the soft anion is aromatic.

Preferably, the soft anion is basic.

Still more preferably, the soft anion is aromatic and basic.

In accordance with the present invention, the soft anion may be selected from: [S₂CNR₂]⁻, [S₂CSR]⁻, [S₂COR]⁻ and [S₂CNR₂]⁻, wherein R may be hydrogen, a C₁ to C₄₀ straight chain or branched alkyl group, a C₃ to C₈ cycloalkyl group, or a C₅ to C₁₀ aryl group, and wherein said alkyl, cycloalkyl or aryl groups may be unsubstituted, or substituted by one to three groups selected from: C₁ to C₆ alkoxy, C₈ to C₁₀ aryl, CN, OH, SH, NO₂, C₇ to C₃₀ aralkyl or C₇ to C₃₀ alkaryl.

More preferably, R is selected from a C₁ to C₁₀ straight chain or branched alkyl group, a C₅ to C₇ cycloalkyl group, or a C₅ to C₈ aryl group, wherein said alkyl, cycloalkyl or aryl groups are unsubstituted or may be substituted by one to three groups selected from: C₁ to C₆ alkoxy, C₆ to C₈ aryl, CN, OH, SH, NO₂, C₈ to C₁₅ aralkyl or C₈ to C₁₅ alkaryl.

Still more preferably, R is selected from a C₁ to C₆ straight chain or branched alkyl group a C₅ to C₆ cycloalkyl group, or a C₅ to C₆ aryl group, wherein said alkyl, cycloalkyl or aryl groups are unsubstituted or may be substituted by one to three groups selected from: C₁ to C₆ alkoxy, C₆ to C₈ aryl, CN, OH, SH, NO₂, C₈ to C₁₅ aralkyl or C₈ to C₁₅ alkaryl.

Further examples of R include:

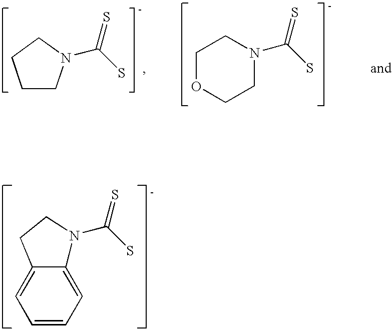

The soft anion may also be selected from: [O₂CR]⁻ wherein R is hydrogen or a C₁ to C₄₀ straight chain or branched alkyl group, and may be substituted by one to three OH groups. Preferably R is a C₁ to C₆ straight chain alkyl group substituted by one OH group. More preferably, R is —CH(OH)CH₃. Alternatively, R may be C₁ to C₁₅ unsubstituted straight chain alkyl, preferably C₅ to C₁₂ alkyl and most preferably C₉ alkyl. The soft anion may also be selected from: [SO₃R]⁻ wherein R is a C₁ to C₄₀ straight chain or branched alkyl group substituted by one to three SH groups. Preferably, R is a C₁ to C₈ straight chain alkyl group substituted by one OH group. More preferably, R is —CH₂—CH₂—SH.

Other examples include: [S₂CSBu]⁻, [(S₂CSCH₂CH₂)S]²⁻, [(S₂CSCH₂)]²⁻, [S₂CNEt₂]⁻, [S₂CN(CHMe₂)₂]⁻, [S₂CN(CH₂)₂]⁻, [S₂CN(CH₂)₄]⁻, [S₂COMe]⁻, [S₂COEt]⁻, [S₂COCHMe₂]⁻, [S₂COBu]⁻, [SO₃(CH₂)₂SH]⁻ and [S₂COPent]⁻ in which elemental sulphur has an unexpectedly high solubility.

The anion for use in the present invention may also be [N(CN)₂]⁻.

The cation may comprise or consist of a heterocyclic ring structure selected from imidazolium, pyridinium, pyrazolium, thiazolium, isothiazolinium, azathiazolium, oxothiazolium, oxazinium, oxazolium, oxaborolium, dithiazolium, triazolium, selenozolium, oxaphospholium, pyrollium, borolium, furanium, thiophenium, phospholium, pentazolium, indolium, indolinium, oxazolium, isooxazolium, isotriazolium, tetrazolium, benzofuranium, dibenzofuranium, benzothiophenium, dibenzothiophenium, thiadiazolium, pyrimidinium, pyrazinium, pyridazinium, piperazinium, piperidinium, morpholinium, pyranium, annolinium, phthalazinium, quinazolinium, quinazalinium, quinolinium, isoquinolinium, thazinium, oxazinium, azaannulenium and pyrrolidinium.

More preferably, the cation comprises or consists of a heterocyclic ring structure selected from imidazolium, pyridinium, pyrazolium, thiazolium, pyrimidinium, piperazinium, piperidinium, morpholinium, quinolinium, isoquinolinium and pyrrolidinium.

Preferably the cation is selected from:—

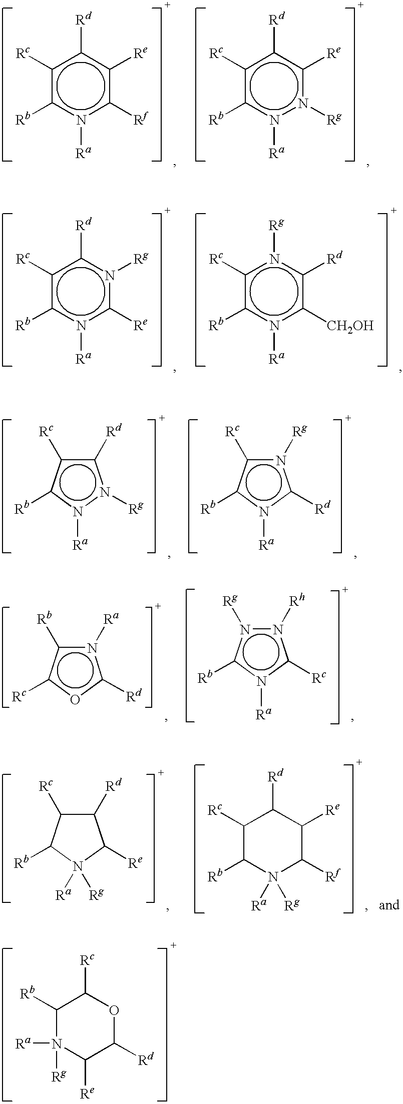

wherein: R^{a}, R^{b}, R^{c}, R^{d}, R^{e}, R^{f}, R^{g} and R^{h} can be the same or different, and are each independently selected from hydrogen, a C₁ to C₄₀, straight chain or branched alkyl group, a C₃ to C₈ cycloalkyl group, or a C₆ to C₁₀ aryl group, wherein said alkyl, cycloalkyl or aryl groups are unsubstituted or may be substituted by one to three groups selected from: C₁ to C₆ alkoxy, C₆ to C₁₀ aryl, CN, OH, NO₂, C₇ to C₃₀ aralkyl and C₇ to C₃₀ alkaryl, or any two of R^{b}, R^{c}, R^{d}, R^{e} and R^{f} attached to adjacent carbon atoms form a methylene chain —(CH₂)_{q}— wherein q is from 8 to 20.

According to another aspect of the present invention, the ionic liquid comprises a soft anion and a soft cation.

The inventors of the present invention have found that the solubility of the elements phosphorus, selenium, tellurium and/or sulphur in the ionic liquids is more sensitive to the anion selected. Nevertheless, the selected cation can also affect solubility. Like the soft anion, the soft cation is preferably aromatic.

Preferably, the soft cation is basic.

More preferably, the soft cation is aromatic and basic.

Where the soft cation is basic, it may comprise: (i) a positively charged moiety and (ii) a basic moiety.

The basic ionic liquids for use in the present embodiment of the invention may be represented by the formula:

[Cat⁺-Z-Bas][X⁻]

wherein: Cat⁺=positively charged moiety:
Bas=basic moiety; and
Z=a covalent bond joining Cat⁺ and Bas, or 1, 2 or 3 aliphatic divalent linking groups each containing 1 to 10 carbon atoms and each optionally one, two or three oxygen atoms.
X⁻=soft anion as described above

Preferably, Bas comprises at least one nitrogen, phosphorus, sulphur, oxygen or boron atom, for example, Bas may comprise at least one primary, secondary or tertiary amino group.

Preferably, Bas is selected from —N(R₁)(R₂), and —P(R₁)(R₂)(R₃); and wherein R₁, R₂ and R₃ can be the same or different and are each independently selected from hydrogen, linear or branched alkyl, cycloalkyl, aryl and substituted aryl.

Preferably, R₁, R₂ and R₃ are each selected from hydrogen, methyl, ethyl, isopropyl, propyl, butyl, sec-butyl, isobutyl, pentyl, hexyl, cyclohexyl, benzyl and phenyl.

Still more preferably, Bas is —N(CH₃)₂ or —N(CH(CH₃)₂)₂.

Preferably Bas is not —O(R₁), wherein R₁ is as defined above. More preferably, Bas is not —OH.

Another aspect of the present invention is directed to use of compounds which are basic ionic liquids and wherein Bas is a hindered basic moiety.

The term “hindered basic moiety” refers to a functional group that acts as a base, but because of steric hinderance, does not chemically bond to the reagents or products.

For hindered basic ionic liquids the group R should have low nucleophilicity such as that described for Hunig's base (bis-(diisopropyl)ethylamine) (see Tetrahedron Letters 1981, 31, 1483). Also in this respect, reference is made to paper, “Hindered non-nuclepohilic base with high protein affinity”, Chem. Ber. 1958, 91, p 380 ad Chem. Ber., 1993, 29, p 1042. This means that the basic group R is capable of forming a chemical bond with free hydrogen ions, but does not form chemical bonds with the reagents or products in a chemical process.

The Bas moiety should have lower nucleophilicity or greater steric hinderance than that given be three ethyl groups attached to the nitrogen as disclosed in WO 04/029004.

In accordance with the present invention Z may be selected from linear or branched C₁ to C₁₈ alkanediyl, substituted alkanediyl, dialkanylether or dialkanylketone, preferably C₁ to C₈ and more preferably C₂ to C₆.

Preferably, Z is selected from —(CH₂—CH₂)—, (CH₂—CH₂—CH₂)—, —(CH₂—CH₂—CH₂—CH₂)—, —(CH₂—CH₂—CH₂—CH₂—CH₂)—, —(CH₂—CH₂—CH₂—CH₂—CH₂—CH₂)—, —(CH₂—CH₂—O—CH₂—CH₂)— and —(CH₂—CH₂—O—CH₂—CH₂—CH₂)—.

The Cat⁺ moiety may comprise or consist of a heterocyclic ring structure selected from imidazolium, pyridinium, pyrazolium, thiazolium, isothiazolinium, azathiozolium, oxothiazolium, oxazinium, oxazolium, oxaborolium, dithiozolium, triazolium, selenozolium, oxaphospholium, pyrollium, borolium, (uranium, thiophenium, phospholium, pentazolium, indolium, indolinium, oxazolium, isooxazolium, isotriazolium, tetrazolium, benzofuranium, dibenzofuranium, benzothiophenium, dibenzothiophenium, thiadiazolium, pyrimidinium, pyrazinium, pyridazinium, piperazinium, piperidinium, morpholinium, pyranium, annolinium, phthalazinium, quinazolinium, quinazalinium, quinolinium, isoquinolinium, thiazinium, oxazinium and azaannulenium.

Preferred Cat⁺-Z-Bas in accordance with the present invention may be selected from:

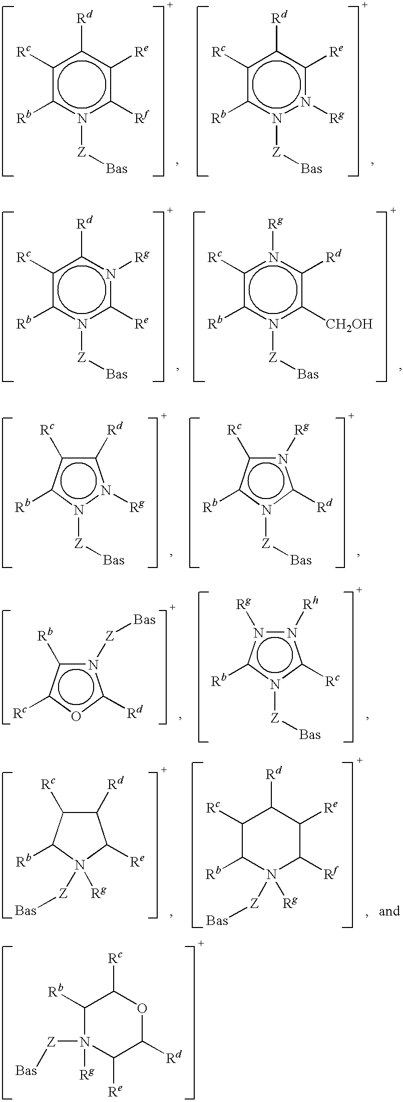

wherein: Bas and Z are as defined above; and R^{b}, R^{c}, R^{d}, R^{e}, R^{f}, R^{g} and R^{h} can be the same or different, and are each independently selected from hydrogen, a C₁ to C₄₀, straight chain or branched alkyl group, a C₃ to C₈ cycloalkyl group, or a C₆ to C₁₀ aryl group, wherein said alkyl, cycloalkyl or aryl groups are unsubstituted or may be substituted by one to three groups selected from: C₁ to C₆ alkoxy, C₆ to C₁₀ aryl, CN, OH, NO₂, C₇ to C₃₀ aralkyl and C₇ to C₃₀ alkaryl, or any two of R^{b}, R^{c}, R^{d}, R^{e} and R^{f} attached to adjacent carbon atoms form a methylene chain —(CH₂)_{q}— wherein q is from 8 to 20.

More preferably Cat⁺-Z-Bas is selected from:—

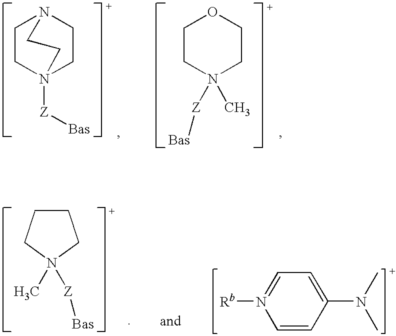

wherein: Bas, Z and R^{b} are as defined above.

Still more preferably, Cat⁺-Z-Bas may be selected from the group consisting of:—

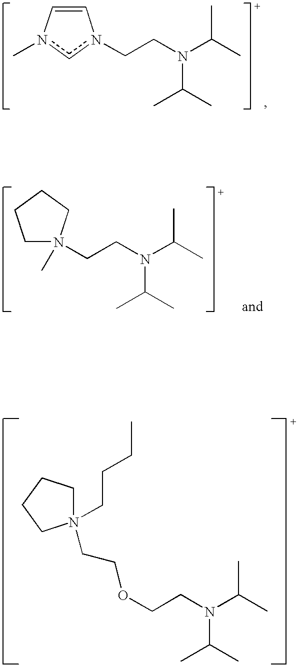

(all of the compounds above being considered “hindered”)

The Cat⁺ moiety for use in the present invention may be obtained by alkylation, protonation and/or acylation of a precursor selected from imidazoles, pyridines, pyrazoles, thiazoles, isothiazoles, azathiozoles, oxothiazoles, oxazines, oxazolines, oxazoboroles, dithiozoles, triazoles, selenozoles, oxaphospholes, pyrroles, boroles, furans, thiophenes, phospholes, pentazoles, indoles, indolines, oxazoles, isooxazoles, isotriazoles, tetrazoles, benzofurans, dibenzofurans, benzothiophenes, dibenzothiophenes, thiadiazoles, pyrimidines, pyrazines, pyridazines, piperazines, piperidines, morpholines, pyrans, annolines, phthalzines, quinazolines, quinoxalines, quinolines, isoquinolines, thiazines, oxazines, and azaannulenes.

In accordance with the present invention, the Cat⁺ moiety may also be an acyclic organic ion.

Where the Cat⁺ moiety is acyclic, it preferably comprises or consists of a group selected from amino amidino, imino, guanidino, phosphino, arsino, stibino, alkoxyalkyl, alkylthio, alkylseleno and phosphinimino.

In one embodiment, the acyclic Cat⁺ moiety is Cat⁺-Z-Bas and is preferably selected from:

[N(Z-Bas)(R^{b})(R^{c})(R^{d})]⁺ and [P(Z-Bas)(R^{b})(R^{c})(R^{d})]⁺
wherein: Bas, Z, R^{b}, R^{c}, and R^{d} are as defined above.

More preferably, Cat⁺-Z-Bas is selected from:

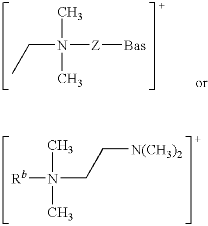

wherein: Bas, Z and R^{b} are as defined above.

Still more preferably, Cat⁺-Z-Bas is selected from:

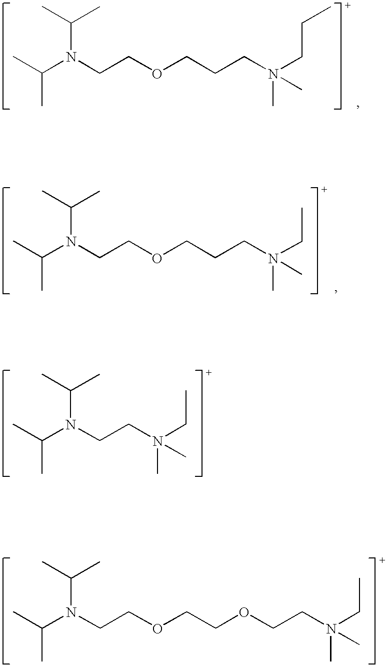

(all of the above compounds being considered “hindered” basic ionic liquids)
   and

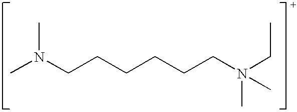

In accordance with the present invention, Cat⁺-Z-Bas may also be:

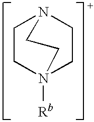

wherein: R^{b} is as defined above.

In another embodiment, the acyclic Cat⁺ moiety is selected from:

[N(R^{a})(R^{b})(R^{c})(R^{d})]⁺ and [P(R^{a})(R^{b})(R^{c})(R^{d})]⁺
wherein: R^{a}, R^{b}, R^{c} and R^{d} are as defined above.

Preferably R^{a}, R^{b}, R^{c} and R^{d} are independently selected from C₁ to C₄₀ alkyl, preferably C₁ to C₂₀ alkyl, still more preferably C₁ to ₁₅ alkyl.

Preferably, Cat⁺ is [C_{6,6,6,14}P]⁺.

In one preferred embodiment where Cat⁺ is [C_{6,6,6,14}P]⁺, the anion X⁻ may be selected from:

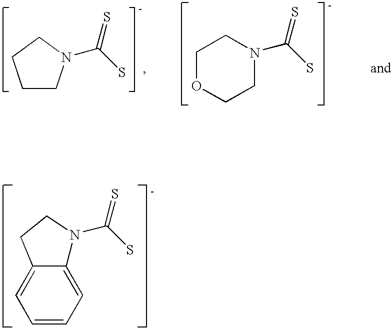

Such an ionic liquid has been shown to be good for dissolving sulphur, phosphorus, selenium and tellurium (particularly sulphur and selenium).

The solubility of the elements, preferably sulphur, in the ionic liquids of the present invention is at least 0.05 g g⁻¹.

Preferably, the solubility is at least 0.05 g g⁻¹ at 110° C.

More preferably, the solubility is at least 0.08 g g⁻¹ at 110° C.

Still more preferably, the solubility is at least 0.10 g g⁻¹ at 110° C.

Yet still more preferably, the solubility is at least 0.15 g g⁻¹ at 110° C.

Even more preferably, the solubility is at least 0.20 g g⁻¹ at 110° C.

Still yet more preferably, the solubility is at least 0.25 g g⁻¹.

Still even more preferably, the solubility is at least 0.30 g g⁻¹ at 110° C.

Even yet more preferably, the solubility is at least 0.35 g g⁻¹ at 110° C.

Even still more preferably, the solubility is at least 0.40 g g⁻¹ at 110° C.

Still further preferably, the solubility is at least 0.50 g g⁻¹ at 110° C.

Yet further preferably, the solubility is at least 0.60 g g⁻¹ at 110° C.

Most preferably, the solubility is at least 0.70 g g⁻¹ at 110° C.

Preferably, the solubility is at least 0.30 g g⁻¹ at 120° C.

More preferably, the solubility is at least 0.40 g g⁻¹ at 120° C.

Most preferably, the solubility is at least 1.00 g g⁻¹ at 120° C.

According to a further aspect of the present invention, there is provided a method of dissolving sulphur, phosphorus, selenium, and/or tellurium comprising the step of adding sulphur, phosphorus, selenium and/or tellurium to an ionic liquid as described above.

Preferably, sulphur or selenium is dissolved in the ionic liquid more preferably sulphur.

According to yet a further aspect of the present invention, there is provided a method for crystallising sulphur comprising the steps of:
(i) dissolving sulphur in an ionic liquid to form a solution;
(ii) crystallising sulphur from the solution.

The method for cyrstallisation may also be applied for use with phosphorus, selenium and/or tellurium.

The present invention will now be discussed by way of example.

### EXAMPLES

### General Method for the Determination of the Solubility Values

The applied ionic liquids of the present invention are characterized by relatively high viscosity at room temperature. Accordingly, measurements were carried out at higher temperatures. (All of the used ionic liquids are stable at the given temperature range (DSC)).

To a measured amount (0.800-1.200 g) of ionic liquid, a small amount (0.050 g) of S₈ was added at 110-135° C. The solubility values were determined as the amount of sulphur that gives a clear solution at the given temperature.

The ionic liquids used in the present invention may be produced using known means, or, for example, using reactions as, or similar to, those described below.

### Dithiocarbamate Ionic Liquids

A two-step synthesis was used to produce a range of dithiocarbamate ionic liquids:

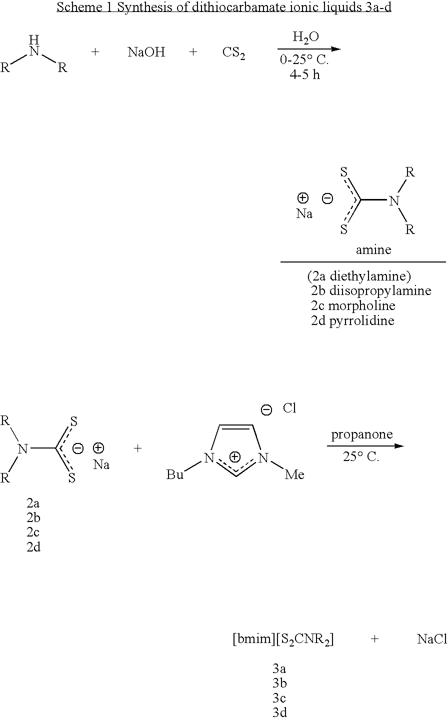

Synthesis of Sodium Dithiocarbamates (2a-d)

Carbon disulfide (12 mmol) was added to an ice-cooled solution of the appropriate amine (10 mmol) and sodium hydroxide (10 mmol) in water (30 ml). The mixture was stirred at room temperature for 6-10 h. The water was evaporated in vacuo and the residue was treated with diethyl ether to give crystalline product.

Reaction of the Sodium Salts (2a-d) with [bmim][Cl]

[bmim][Cl] (10 mmol) was added at room temperature to the appropriate sodium salt (11 mmol). Propanone was added to the liquid formed, and the precipitating sodium chloride was filtered. The filtrate was evaporated in vacuo to give a yellow liquid (Products 3a-d).

The new derivatives all proved to be good solvents for S₈, the best being the pyrrolidine derivative with 0.43 g g⁻¹ solubility.

### Trithiocarbonate Ionic Liquids

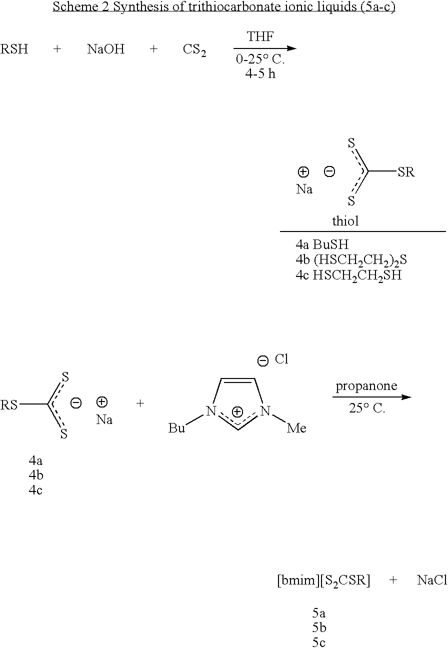

Synthesis of Sodium Trithiocarbonates (4a-c)

To an ice-cooled solution of the appropriate thiol (10 mmol) in tetrahydrofuran (10-20 ml) was added a solution of sodium hydroxide (10 mmol) in water (7 ml). After 10 min, carbon disulfide (12 mmol) was added and the mixture was stirred at room temperature for 6-10 h. The water was evaporated in vacuo and the residue was treated with diethyl ether or ethyl acetate to give crystalline product.

Reaction of the Sodium Salts (4a-c) with [bmim][Cl]

This part of the reaction was carried out as for the dithiocarbonate ionic liquids above to yield products 5a-c.

### Dithiocarbonate Ionic Liquids

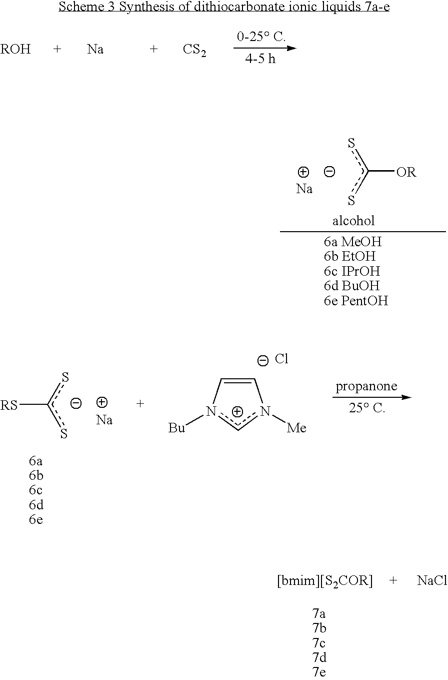

Synthesis of Sodium Dithiocarbonates (6a-e)

To an ice-cooled solution of sodium (10 mmol) in the appropriate alcohol (10 ml) was added carbon disulfide (12 mmol) and the mixture was stirred at room temperature for 6-10 h. The solvent was evaporated in vacuo and the residue was treated with diethyl ether to give crystalline product.

Reaction of the Sodium Salts (6a-e) with [bmim][Cl]

This part of the reaction was carried out as for the dithiocarbonate ionic liquids above to yield products (7a-e).

### Solubility Results I

TABLE 1
Solubility of S₈ in novel type trithiocarbonate,
dithiocarbamate and dithiocarbonate ionic liquids

| | | | Solubility of S₈/g g⁻¹ | | |
|---|---|---|---|---|---|
| Ionic liquid | | | 110° C. | 120-125° C. | 135° C. |
| trithiocarbonates | [bmim][S₂CSBu] | 5a | 0.20 | | 0.30 |
| | [bmim]₂[(S₂CSCH₂CH₂)S] | 5b | 0.09 | | 0.22 |
| | [bmim]₂[(S₂CSCH₂)] | 5c | 0.05 | | 0.13 |
| dithiocarbamates | [bmim][S₂CNEt₂] | 3a | 0.25 | | 0.33 |
| | [bmim][S₂CN(CHMe₂)₂] | 3b | 0.19 | 0.23 | 0.31 |
| | [bmim][S₂CN(CH₂)₂O(CH₂)₂] | 3c | 0.18 | 0.23 | 0.31 |
| | [bmim][S₂CN(CH₂)₄] | 3d | 0.24 | 0.38 | 0.43 |
| dithiocarbonates | [bmim][S₂COMe] | 7a | 0.27 | 0.37 | 0.41 |
| | [bmim][S₂COEt] | 7b | 0.18 | 0.37 | 0.37 |
| | [bmim][S₂COCHMe₂] | 7c | 0.29 | 0.42 | 0.49 |
| | [bmim][S₂COBu] | 7d | 0.37 | 0.47 | 0.52 |
| | [bmim][S₂COPent] | 7e | 0.72 | >1.0 | |

After determining the solubility values (Table 2, compounds 5a-c, 7a-e), it can be seen, that the amount of sulphur in the anion does not seem to affect the solubility. The dithiocarbonates generally appear to be better solvents than the trithiocarbonates, the butyl, isopropyl and pentyl derivatives being even better than the dithiocarbamates.

In considering the influence of the alkyl group on the solvent properties of the dithiocarbonate derivatives, it seems that the solubility generally increases with increasing chain length from the methyl to the pentyl derivative.

Considering the similar structural elements in carboxylic and carbonic acids, a range of carboxylic- and thiocarboxylic acid derivatives was prepared.

### Carboxylic Acid Derivative Ionic Liquids

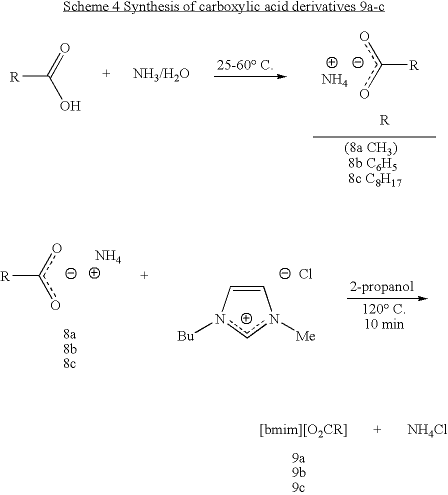

Synthesis of Ammonium Alkyl- and Arylcarboxylates (8a-c)

A mixture of the appropriate carboxylic acid (10 mmol) and a solution of ammonia in water (50 ml, 32%) was stirred at room temperature until complete dissolution of the acid. The solvent was partly evaporated in vacuo. The precipitating crystalline product was filtered and washed with diethyl ether.

Reaction of the Ammonium Salts (8a-c) with [bmim][Cl]

A mixture of the appropriate ammonium salt (11 mmol) and [bmim][Cl] (10 mmol) in 2-propanol (15 ml) was heated at 120° C. (MW) for 10 min. After cooling, the precipitating ammonium chloride was filtered and the filtrate evaporated in vacuo to give yellow liquid. (Products 9a-c).

Compounds 9a-c were synthesised as above due to the low solubility of the sodium salt of the carboxylic acid in acetone.

### Thiobenzoic Acid Ionic Liquids

The thiobenzoic acid derivative 11 was prepared similarly to the carbonic acid derivatives from the appropriate sodium salt (Scheme 6).

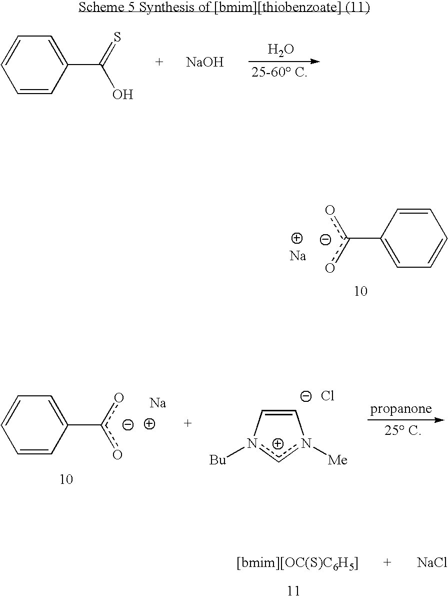

### Synthesis of Sodium Thiobenzoate (10)

A mixture of the thiobenzoic acid (10 mmol) and sodium hydroxide (10 mmol) in water was stirred at room temperature for 1 h. The solvent was evaporated in vacuo and the residue was treated with diethyl ether to give yellow crystalline product.

Synthesis of [bmim][OC(S)C₆H₅] (11)

The sodium salt was reacted with [bmim][Cl] to give orange-yellow liquid.

### Solubility Results II

In spite of the structural similarities, compounds 9a-c and 11 are not good solvents for elemental sulphur (Table 2 below). It seems that best results are obtained where a dithiocarbonic acid structure is present in the ionic liquid.

TABLE 2
Solubility of S₈ in carboxylate and thiocarboxylate ionic liquids

| | | Solubility of S₈/g |
|---|---|---|
| Ionic liquid | | g⁻¹ (110-135° C.) |
| [emim][O₂CCH(OH)CH₃] | 1 | 0.14-0.19 |
| [bmim][O₂CCH₃] | 9a | <0.04 |
| [bmim][O₂CC₆H₅] | 9b | <0.05 |
| [bmim][O₂CC₈H₁₇] | 9c | 0.05 |
| [bmim][OC(S)C₆H₅] | 11 | <0.05 |

### Phosphonium Dithiocarbanate Ionic Liquids

In order to investigate the effect of the cation on the solubility and the stability of the ionic liquid, carbonate-derivative ionic liquids with phosphonium cations were also synthesized.

Compounds 12 and 14a-e were synthesised by reacting the sodium salt of the appropriate dithiocarbamate or dithiocarbonate anion with trihexyl-tetradecylphosphonium chloride in acetone (Scheme 6). The phosphonium analogues proved to be stable, the pyrrolidine derivative 12 being the same even after standing for three months.

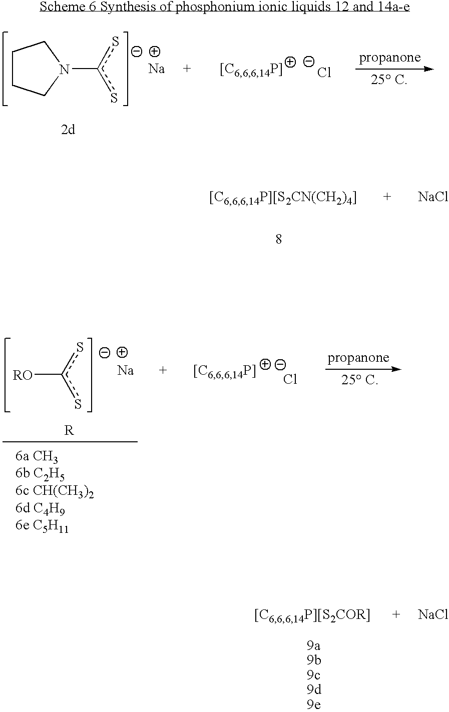

The ionic liquids of this type, i.e. 12 and 14e appear to be at least as good solvents for S₈ as the bmim analogues.

### Mercaptosulfonate Ionic Liquids

Another possible sulphur-containing anion is the 2-mercaptoethanesulfonate anion. Combined with the bmim cation, by reaction of the appropriate sodium and chloride salts in acetone (Scheme 7), the product ionic liquid 16 proved to be similar to [emim][lactate], with the same solubility value of 0.14-0.18 g g⁻¹ at 110-135° C.

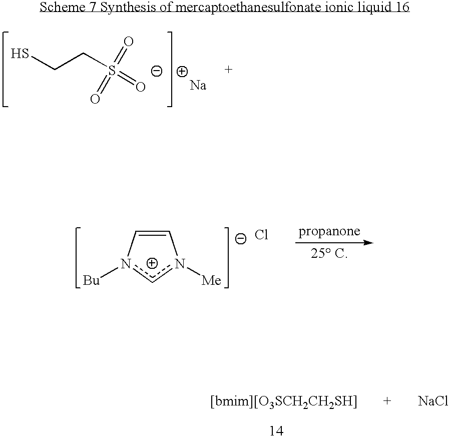

Synthesis of [bmim][O₃SCH₂CH₂SH]

A solution of sodium 2-mercaptoethanesulfonate (18.3 mmol, 3.00 g) and [bmim]Cl (14.6 mmol, 2.55 g) in water (50 cm³) and MeOH (20 cm³) was stirred for 2 h. After evaporation of the solvents in vacuo, acetone (20-50 cm³) was added and the precipitating sodium chloride was filtered. The solvent was evaporated in vacuo to give a yellow liquid in 97% yield.

### Comparative Examples

A comparison of the solubility of S₈ in various ionic liquids was undertaken to show that not all are suitable.

TABLE 3
Solubility of S₈ in various ionic liquids at 110-140° C.

| Ionic liquid | Solubility of S₈/g g⁻¹ (110-140° C.) |
|---|---|
| [emim][EtSO₄] | 0.01 |
| [C₆mim][Cl] | 0.01 |
| [N₈₈₈₁][N(Tf)₂] | 0.02 |
| [C_{666,14}P][Cl] | 0.01-0.02 |
| [C₈mim][BF₄] | <0.01 |
| [emim][O₂CCH(OH)CH₃] (1) | 0.14-0.19 |
| [C₁₀mim][OTf] | <0.01 |
| [C₄mim][N(Tf₂)] | <0.01 |
| [bmim][S₂CNEt₂] (3a) | 0.33 |

Synthesis of [emim][O₂CCH(OH)CH₃] (1)

To a solution of [emim][HSO₄] (10 mmol) in methanol (5 ml) was sodium (S)-lactate (12.5 mmol) added. The mixture was stirred at room temperature for 1 h, followed by the addition of sodium carbonate (˜0.3 g). After 30 min, propanone was added (˜20 ml). The precipitating inorganic salt was filtered and the filtrate evaporated in vacuo to give a colourless liquid.

### Further Comparative Examples

To further investigate the solubility of sulphur in ionic liquids, the S₈ solubilities in several sulfonium ionic liquids was measured (Table 4). As can be seen, none of them proved to be a good solvent for elemental sulphur.

TABLE 4
Solubility of S₈ in sulfonium ionic liquids

| | Solubility of S₈/g |
|---|---|
| Ionic liquid | g⁻¹ (110-135° C.) |
| [Me₃S][NTf₂] | <0.05 |
| [Me₂EtS][EtSO₄] | <0.05 |
| [Me₂(EtO)S][EtSO₄] | <0.05 |
| [Et(CH₂)₄S][HSO₄] | <0.05 |

### General Procedure for the Synthesis of Sulfonium Alkysulfates

To a solution of dmso or the appropriate sulfide (120 mmol) in toluene (50 cm³) dimethyl or diethyl sulfate (100 mmol, 11.13 cm³ and 13.10 cm³ respectively) was added at room temperature, and the mixture was heated for 15-30 min at 110° C. After cooling, the formed ionic liquid layer was separated and washed two times with toluene (˜20 cm³) to remove excess starting material. In all cases, the first toluene layer was poured into a mixture of aqueous ammonia and ethanol to destroy excess dialkyl sulfate, and all the glassware was washed with the same mixture.

The separated product layer was then dried in vacuo to give product in moderate to excellent yields.

### SUMMARY

It is clear from the results above that not all ionic liquids can be used as solvents for sulphur.

Instead, specific ionic liquids, as exemplified in the present specification must be used.

Ionic liquids containing a dithiocarbonate structure provide especially good solvent properties.

Longer alkyl chains appear to enhance solvent properties.

1. Use of an ionic liquid as a solvent for an element selected from sulphur, phosphorus, selenium and/or tellurium, the ionic liquid being composed of at least one species of cation, and at least one species of soft anion.

2. Use according to claim 1, wherein the soft anion is aromatic.

3. Use according to claim 1, wherein the soft anion is basic.

4. Use according to claim 1, wherein the soft anion may be selected from: [S₂CNR₂]⁻, [S₂CSR]⁻, [S₂COR]⁻ and [S₂CNR₂]⁻, wherein R may be hydrogen, a C₁ to C₄₀ straight chain or branched alkyl group, a C₃ to C₈ cycloalkyl group, or a C₅ to C₁₀ aryl group, and wherein said alkyl, cycloalkyl or aryl groups may be unsubstituted, or substituted by one to three groups selected from: C₁ to C₆ alkoxy, C₆ to C₁₀ aryl, CN, OH, SH, NO₂, C₇ to C₃₀ aralkyl or C₇ to C₃₀ alkaryl.

5. Use according to claim 4, wherein R is selected from a C₁ to C₁₀ straight chain or branched alkyl group, a C₅ to C₇ cycloalkyl group, or a C₅ to C₈ aryl group, wherein said alkyl, cycloalkyl or aryl groups are unsubstituted or may be substituted by one to three groups selected from: C₁ to C₆ alkoxy, C₆ to C₈ aryl, ON, OH, SH, NO₂, C₈ to C₁₅ aralkyl or C₈ to C₁₅ alkaryl.

6. Use according to claim 5, wherein R is selected from a C₁ to C₆ straight chain or branched alkyl group a C₅ to C₆ cycloalkyl group, or a C₅ to C₆ aryl group, wherein said alkyl, cycloalkyl or aryl groups are unsubstituted or may be substituted by one to three groups selected from: C₁ to C₆ alkoxy, C₆ to C₈aryl, CN, OH, SH, NO₂, C₈ to C₁₅ aralkyl or C₈ to C₁₅alkaryl.

7. Use according to claim 1, wherein the soft anion is selected from: [O₂CR]⁻ wherein R is a C₁ to C₄₀ straight chain or branched alkyl group substituted by one to three OH groups.

8. Use according to claim 7, wherein R is a C₁ to C₆ straight chain alkyl group substituted by one OH group.

9. Use according to claim 8, wherein R is —CH(OH)CH₃.

10. Use according to claim 1, wherein the soft anion is selected from [SO₃R]⁻ wherein R is a C₁ to C₄₀ straight chain or branched alkyl group substituted by one to three SH groups.

11. Use according to claim 1, wherein the cation may comprise or consist of a heterocyclic ring structure selected from imidazolium, pyridinium, pyrazolium, thiazolium, isothiazolinium, azathiazolium, oxothiazolium, oxazinium, oxazolium, oxaborolium, dithiazolium, triazolium, selenozolium, oxaphospholium, pyrollium, borolium, furanium, thiophenium, phospholium, pentazolium, indolium, indolinium, oxazolium, isooxazolium, isotriazolium, tetrazolium, benzofuranium, dibenzofuranium, benzothiophenium, dibenzothiophenium, thiadiazolium, pyrimidinium, pyrazinium, pyridazinium, piperazinium, piperidinium, morpholinium, pyranium, annolinium, phthalazinium, quinazolinium, quinazalinium, quinolinium, isoquinolinium, thazinium, oxazinium, azaannulenium and pyrrolidinium.

12. Use according to claim 11, wherein the cation comprises or consists of a heterocyclic ring structure selected from imidazolium, pyridinium, pyrazolium, thiazolium, pyrimidinium, piperazinium, piperidinium, morpholenium, quinolinium, isoquinolinium and pyrrolidinium.

13. Use according to claim 11, wherein the cation is selected from:— 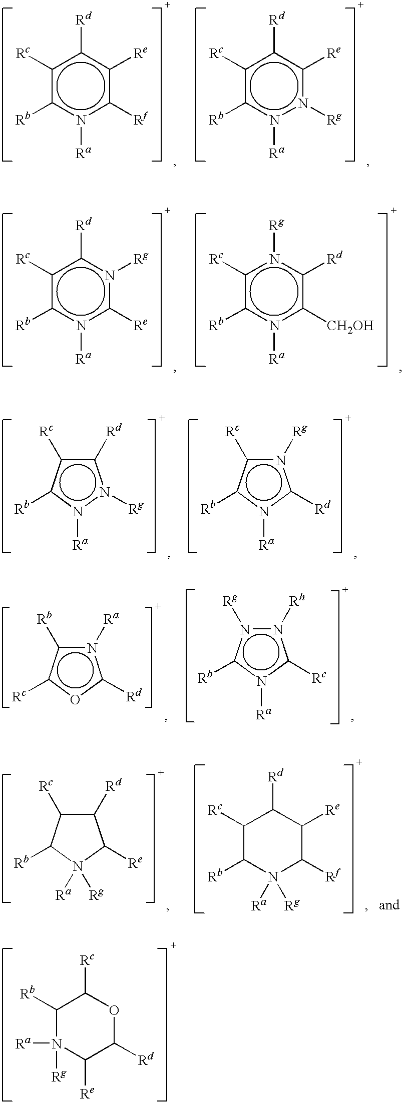
wherein: R^{a}, R^{b}, R^{c}, R^{d}, R^{e}, R^{f}, R^{g} and R^{h} can be the same or different, and are each independently selected from hydrogen, a C₁ to C₄₀, straight chain or branched alkyl group, a C₃ to C₈ cycloalkyl group, or a C₆ to C₁₀ aryl group, wherein said alkyl, cycloalkyl or aryl groups are unsubstituted or may be substituted by one to three groups selected from: C₁ to C₆ alkoxy, C₆ to C₁₀ aryl, CN, OH, NO₂, C₇ to C₃₀ aralkyl and C₇ to C₃₀ alkaryl, or any two of R^{b}, R^{c}, R^{d}, R^{e} and R^{f} attached to adjacent carbon atoms form a methylene chain —(CH₂)_{q}— wherein q is from 8 to 20.

14. Use according to claim 1 according to another aspect of the present invention, the ionic liquid comprises a soft anion and a soft cation.

15. Use according to claim 14, wherein the soft cation is basic.

16. Use according to claim 15, wherein the soft cation is aromatic.

17. Use according to claim 14, wherein the soft cation comprises (i) a positively charged moiety and (ii) a basic moiety.

18. Use according to claim 16, wherein the ionic liquid is represented by the formula:
[Cat⁺-Z-Bas][X⁻]
wherein: Cat⁻=positively charged moiety:
Bas=basic moiety; and
Z=a covalent bond joining Cat⁺ and Bas, or 1, 2 or 3 aliphatic divalent linking groups each containing 1 to 10 carbon atoms and each optionally one, two or three oxygen atoms.
X⁻=soft anion as described above.

19. Use according to claim 18, wherein Bas comprises at least one nitrogen, phosphorus, sulphur, oxygen or boron atom.

20. Use according to claim 19, wherein Bas comprises at least one primary, secondary or tertiary amino group.

21. Use according to claim 19, wherein Bas is selected from —N(R₁)(R₂), and —P(R₁)(R₂)(R₃); and wherein R₁, R₂ and R₃ can be the same or different and are each independently selected from hydrogen, linear or branched alkyl, cycloalkyl, aryl and substituted aryl.

22. Use according to claim 21, wherein R₁, R₂ and R₃ are each selected from hydrogen, methyl, ethyl, isopropyl, propyl, butyl, sec-butyl, isobutyl, pentyl, hexyl, cyclohexyl, benzyl and phenyl.

23. Use according to claim 22, wherein Bas is —N(CH₃)₂ or —N(CH(CH₃)₂)₂.

24. Use according to claim 18, wherein Z is selected from linear or branched C₁ to C₁₈ alkanediyl, substituted alkanediyl, dialkanylether or dialkanylketone, preferably C₁ to C₈ and more preferably C₂ to C₆.

25. Use according to claim 24, wherein Z is selected from —(CH₂—CH₂)—, (CH₂—CH₂—CH₂)—, —(CH₂—CH₂—CH₂—CH₂)—, —(CH₂—CH₂—CH₂—CH₂—CH₂)—, —(CH₂—CH₂—CH₂—CH₂—CH₂—CH₂)—, —(CH₂—CH₂—O—CH₂—CH₂)— and —(CH₂—CH₂—O—CH₂—CH₂—CH₂)—.

26. Use according to claim 18, wherein Cat⁺ comprises or consists of a heterocyclic ring structure selected from imidazolium, pyridinium, pyrazolium, thiazolium, isothiazolinium, azathiazolium, oxothiazolium, oxazinium, oxazolium, oxaborolium, dithiazolium, trizdium, selenozolium, oxaphospholium, pyrollium, borolium, furanium, thiophenium, phospholium, pentazolium, indolium, indolinium, oxazolium, isooxazolium, isotriazolium, tetrazolium, benzofuranium, diborzofuranium, benzothiophenium, dibunzothiophenium, thiadiazolium, pyrimidinium, pyrazinium, pyridazinium, piperazinium, piperidinium, morpholinium, pyranium, annolinium, phthalazinium, quinazolinium, quinazalinium, quinolinium, isoquinolinium, thazinium, oxazinium and azaannulenium.

27. Use according to claim 26, wherein Cat⁺-Z-Bas is selected from: 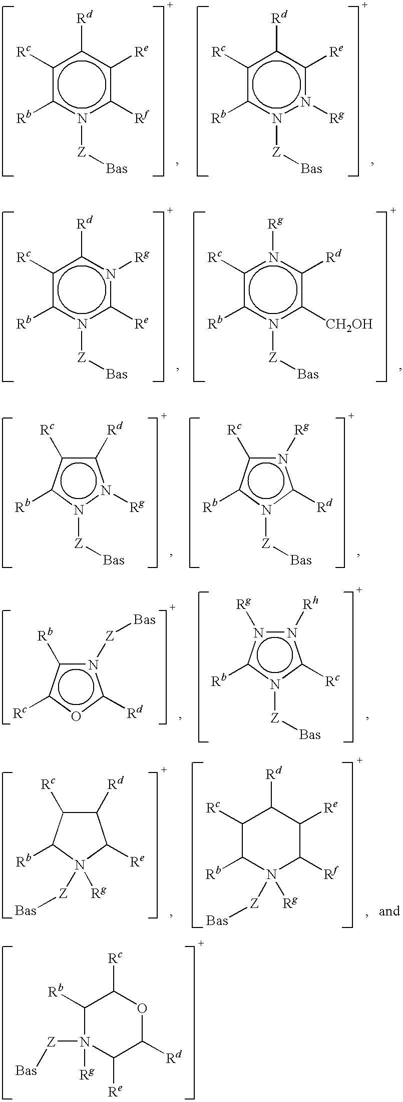
wherein: Bas and Z are as defined above; and R^{b}, R^{c}, R^{d}, R^{e}, R^{f}, R^{g} and R^{h} can be the same or different, and are each independently selected from hydrogen, a C₁ to C₄₀, straight chain or branched alkyl group, a C₃ to C₈ cycloalkyl group, or a C₆ to C₁₀ aryl group, wherein said alkyl, cycloalkyl or aryl groups are unsubstituted or may be substituted by one to three groups selected from: C₁ to C₆ alkoxy, C₆ to C₁₀ aryl, CN, OH, NO₂, C₇ to C₃₀ aralkyl and C₇ to C₃₀ alkaryl, or any two of R^{b}, R^{c}, R^{d}, R^{e} and R^{f} attached to adjacent carbon atoms form a methylene chain —(CH₂)_{q}— wherein q is from 8 to 20.

28. Use according to claim 1, wherein the solubility of the element in the ionic liquids of the present invention is at least 0.05 g g⁻¹.

29. Use according to claim 28, wherein the solubility is at least 0.05 g g⁻¹ at 110° C.

30. Use according to claim 29, wherein the solubility is at least 0.10 g g⁻¹ at 110° C.

31. Use according to claim 30, wherein the solubility is at least 0.20 g g⁻¹ at 110° C.

32. Use according to claim 31, wherein the solubility is at least 0.40 g g⁻¹ at 110° C.

33. Use according to claim 32, wherein the solubility is at least 0.70 g g⁻¹ at 110° C.

34. Use according to claim 1, wherein the element is sulphur.

35. A method of dissolving an element selected from sulphur, phosphorus, selenium and/or tellurium sulphur comprising the step of adding the element to an ionic liquid composed of at least one species of cation, and at least one species of soft anion.

36. A method for crystallising an element selected from sulphur, phosphorus, selenium and/or tellurium, comprising the steps of:
(i) dissolving the element in an ionic liquid to form a solution;
(ii) crystallising the element from the solution.

37. A method according to claim 35, wherein the element is sulphur.

38. A method according to claim 36, wherein the element is sulphur.
